(19) United States
(12) Patent Application Publication
(10) Pub. No.: US 2026/0235933 A1
(43) Pub. Date: Aug. 13, 2026

(54) LENS BARREL AND IMAGING DEVICE

(71) Applicant: NIKON CORPORATION, Tokyo (JP)

(72) Inventors: Satoshi YAMADA, Tokyo (JP); Masateru ASAYAMA, Kawasaki-shi (JP); Kazuaki KAMIO, Tokyo (JP)

(73) Assignee: NIKON CORPORATION, Tokyo (JP)

(21) Appl. No.: 19/160,756

(22) PCT Filed: Mar. 28, 2024
(86) PCT No.: PCT/JP2024/012728

§ 371 Date: Aug. 28, 2025

(30) Foreign Application Priority Data
Apr. 17, 2023 (JP) 2023-067202

(51) Int. Cl. G03B 17/02

(52) U.S. Cl. CPC G03B 17/02

(57) ABSTRACT

A lens barrel includes a first member having conductivity, a second member that has conductivity and is disposed closer to an image plane side than the first member, a non-conductive member at least a portion of which is disposed between the first member and the second member, and a conductive member that fixes a fixed member to the non-conductive member and electrically connects the first member and the second member.

### CROSS-REFERENCE TO RELATED APPLICATION

This application is a national stage application of the prior International Patent Application No. PCT/JP 2024/012728, filed on Mar. 28, 2024, which is based upon and claims the benefit of priority of the prior Japanese Patent Application No. 2023-067202, filed on Apr. 17, 2023, the entire contents of which are incorporated herein by reference.

### FIELD

The present disclosure relates to a lens barrel and an imaging device.

### BACKGROUND

In order to inhibit the occurrence of charging or discharging due to static electricity in a conductive member of a lens barrel, it is known to electrically connect the conductive member to a ground potential of an electric circuit provided in the main body of an imaging device (for example, see Patent Literature 1).

### CITATION LIST

### Patent Literature

PTL 1: Japanese Patent Application Publication No. 2002-357757

### SUMMARY

According to a first aspect, a lens barrel includes a first member having conductivity; a second member that has conductivity and is disposed closer to an image plane side than the first member; a non-conductive member at least a portion of which is disposed between the first member and the second member; and a conductive member that fixes a fixed member to the non-conductive member and electrically connects the first member and the second member.

According to a second aspect, an imaging device includes the above lens barrel.

The configuration of the embodiments described later may be appropriately modified, and at least a part thereof may be replaced with another configuration. Furthermore, the constituent elements whose arrangement is not particularly limited are not limited to the arrangement disclosed in the embodiment, and can be arranged at positions where the functions thereof can be achieved.

### BRIEF DESCRIPTION OF THE DRAWINGS

FIG. 1 is a diagram illustrating a camera including a lens barrel according to a first embodiment and a camera body.

FIG. 2 is an enlarged view of a portion enclosed by a broken line in FIG. 1.

FIG. 3 is an enlarged view of a portion enclosed by a dotted line in FIG. 1.

FIG. 4 is a diagram illustrating a camera including a lens barrel according to a second embodiment and the camera body.

FIG. 5 is an enlarged view of a portion enclosed by a broken line in FIG. 4.

### DESCRIPTION OF EMBODIMENTS

### First Embodiment

Hereinafter, a lens barrel 100 according to a first embodiment will be described in detail with reference to the drawings. The shapes and the scales such as the lengths, thicknesses, and the like of the components illustrated in the embodiments do not necessarily identical to those of the actual ones, and some components may be omitted in the drawings for easy understanding. In the cross-sectional views, hatching of some elements is omitted.

In the following description, a direction parallel to an optical axis OA of an imaging optical system may be referred to as a “front-rear direction” unless otherwise specified. In addition, a subject side is referred to as an “object side”, and a side opposite to the subject in the optical axis OA direction (camera body side) is referred to as an “image plane side”.

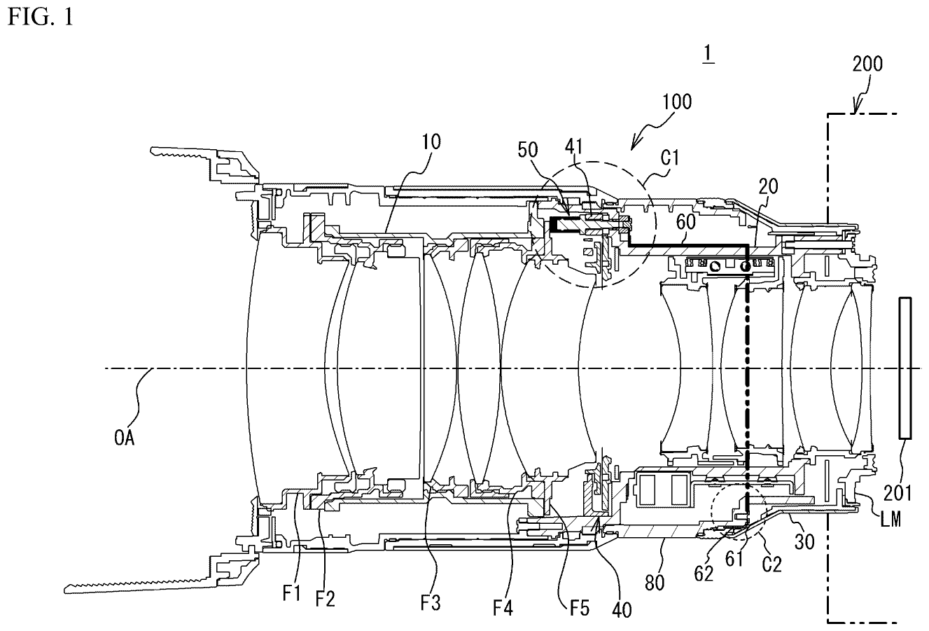

FIG. 1 is a diagram illustrating a camera 1 including the lens barrel 100 according to a first embodiment and a camera body 200. In the present embodiment, the lens barrel 100 is detachable from the camera body 200, but this does not intend to suggest any limitation, and the lens barrel 100 and the camera body 200 may be integrated. The camera body 200 may be dedicated to shooting videos as well as capable of shooting still images.

The camera body 200 includes an image sensor 201, a control unit (not illustrated), and the like inside. The image sensor 201 is composed of a photoelectric conversion element such as a CCD (Charge Coupled Device), and converts a subject image formed by the imaging optical system (the lens barrel 100 mounted on the camera body 200) into an electrical signal.

The control unit includes a CPU (Central Processing Unit) and the like, and integrally controls the overall operation of the camera 1 related to photographing including focusing driving in the image sensor 201 and the attached lens barrel 100.

As illustrated in FIG. 1, the lens barrel 100 according to the present embodiment includes a first fixed barrel (first member) 10, a second fixed barrel (non-conductive member) 20, an exterior barrel 30 (second member), a lens mount LM, and a diaphragm unit 40 (fixed member). In the present embodiment, the first fixed barrel 10 and the second fixed barrel 20 do not move in the optical axis OA direction, but at least one of the first fixed barrel 10 and the second fixed barrel 20 may move in the optical axis OA direction or may rotate about the optical axis OA as a central axis.

A plurality of lens holding frames F1 to F5 are fixed to the first fixed barrel 10, and each of the plurality of lens holding frames F1 to F5 holds one or a plurality of lenses. In the present embodiment, the lens holding frames F1 to F5 are made of metal and are connected to the first fixed barrel 10. Therefore, the first fixed barrel 10 and the lens holding frame F5 are electrically connected to each other. The lens holding frames F1 to F4 may be made of resin. The number of lens holding frames fixed to the first fixed barrel 10 may be four or less or six or more.

The exterior barrel 30 and the lens mount LM are separated from the first fixed barrel 10 in the optical axis OA direction and are disposed closer to the image plane side than the first fixed barrel 10. The exterior barrel 30 is made of metal and has conductivity.

The lens mount LM enables the lens barrel 100 to be attached to and detached from the camera body 200. The lens mount LM has electronic contacts for transmitting and receiving signals between a control unit (not illustrated) provided in the camera body 200 and various driving devices in the lens barrel 100. The lens mount LM is made of metal and has conductivity. The lens mount LM is electrically connected to the exterior barrel 30.

At least a part of the second fixed barrel 20 is disposed between the first fixed barrel 10 and the exterior barrel 30 in the optical axis OA direction. In the present embodiment, a focus lens group is disposed inside the second fixed barrel 20. The second fixed barrel 20 is made of resin and has no conductivity (is non-conductive). The component disposed inside the second fixed barrel 20 may be other than the focus lens group, and may be an image stabilization unit. Further, drive sources for the focus lens group and the image stabilization unit, and a mechanism for guiding the focus lens group in the optical axis OA direction may be disposed inside the second fixed barrel 20. When a lens that moves in the optical axis OA direction is arranged inside the second fixed barrel 20, the length of the second fixed barrel 20 in the optical axis OA direction is proportional to the amount of movement of the lens.

The diaphragm unit 40 has an opening member 41, and in the present embodiment, the diaphragm unit 40 is fixed to the second fixed barrel 20 by fixing the opening member 41 to the second fixed barrel 20. In the present embodiment, the opening member 41 is made of resin and does not have conductivity.

As a method of inhibiting the occurrence of charging or discharging due to static electricity in the conductive first fixed barrel 10, it is conceivable to electrically connect the first fixed barrel 10 to the ground potential of an electric circuit provided in the camera body 200. For example, by connecting one end of a copper foil to the first fixed barrel 10 and connecting the other end of the copper foil to the lens mount LM, the first fixed barrel 10 can be electrically connected to the ground potential provided in the camera body 200.

However, in this case, it is necessary to take measures such as disposing the copper foil so as to bypass various components, adding a conductive component in the lens barrel, and the like. As a result, the number of components increases, leading to higher component cost of the lens barrel. Further, the lens barrel is increased in size in order to secure a space for disposing the conductive component in the lens barrel. Further, there is a possibility that the copper foil is peeled off, and thus there is a problem that the reliability is low.

Therefore, in the present embodiment, the lens barrel 100 includes a conduction fixing mechanism (conductive member) 50 having a function of fixing the components and a conduction function of electrically connecting the first fixed barrel 10 to the ground potential. Specifically, the conduction fixing mechanism 50 and the diaphragm unit 40 are fixed to and electrically connected to the second fixed barrel 20.

In the present embodiment, the diaphragm unit 40 is fixed to the second fixed barrel 20 at three points, and the conduction fixing mechanism 50 is used at one of the three points. At the remaining two fixing points, the diaphragm unit 40 is fixed to the second fixed barrel 20 using ordinary screw members. At the remaining two fixing points, the diaphragm unit 40 is fixed to the second fixed barrel 20 without using a screw portion 52 and a nut 53, which will be described later, and thus a compression coil spring 51, which will be described later, is not present between the diaphragm unit 40 and the lens holding frame F5, and a space is formed.

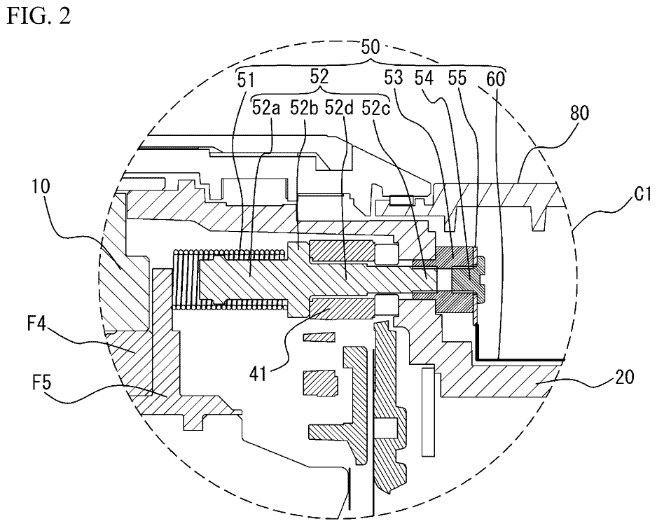

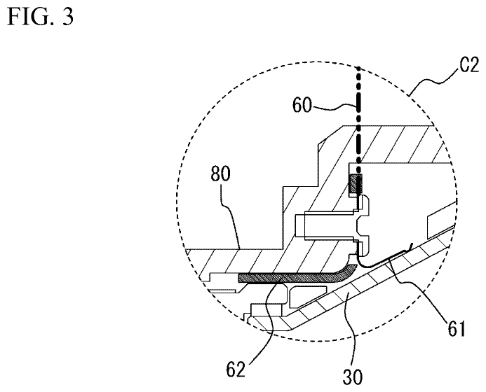

The conduction fixing mechanism 50 will be described in detail with reference to FIG. 2 and FIG. 3. FIG. 2 is an enlarged view of a portion C1 enclosed by a broken line in FIG. 1. FIG. 3 is an enlarged view of a portion C2 enclosed by a dotted line in FIG. 1.

As illustrated in FIG. 2, the conduction fixing mechanism 50 includes the compression coil spring (elastic member) 51, the screw portion (fixing portion) 52, the nut 53, a screw 54, a first lug plate 55, and a lead wire 60. The compression coil spring 51, the screw portion 52, the nut 53, the screw 54, and the first lug plate 55 are made of metal and have conductivity.

The screw portion 52 extends in a direction parallel to the optical axis OA, and includes a spring engagement portion 52a, a spring contact portion 52b, a penetration portion 52d, and a nut engagement portion 52c. In the direction parallel to the optical axis OA, the lens holding frame F5 and the screw portion 52 are not in direct contact with each other.

The spring engagement portion 52a is inserted into the compression coil spring 51 and engages with the compression coil spring 51. The spring engagement portion 52a restricts the movement of the compression coil spring 51 other than the expansion and contraction in the direction parallel to the optical axis OA.

The spring contact portion 52b is disposed between the spring engagement portion 52a and the penetration portion 52d in the direction parallel to the optical axis OA, and protrudes radially outward. Thus, the spring contact portion 52b is in contact with one end of the compression coil spring 51.

Here, since the other end of the compression coil spring 51 is in contact with the lens holding frame F5 and the lens holding frame F5 is in contact with the first fixed barrel 10, the first fixed barrel 10 and the screw portion 52 are electrically connected by the compression coil spring 51. Since the compression coil spring 51 is expandable and contractible in the direction parallel to the optical axis OA, even if there is a variation in the distance (clearance) between the lens holding frame F5 and the spring contact portion 52b due to manufacturing errors or the like, the lens holding frame F5 (first fixed barrel 10) and the screw portion 52 can be electrically connected to each other reliably by the expansion and contraction of the compression coil spring 51.

The penetration portion 52d penetrates through a part of the opening member 41 and a part of the second fixed barrel 20.

The nut engagement portion 52c has, for example, a screw thread and engages with a screw groove of the nut 53. The nut 53 engages with the screw 54 in addition to the nut engagement portion 52c of the screw portion 52. The screw 54 fixes the first lug plate 55 to the nut 53.

The lead wire 60 is connected to the first lug plate 55. The lead wire 60 is, for example, soldered to the first lug plate 55. As illustrated in FIG. 1, the lead wire 60 extends from the first lug plate 55 toward the image plane side along the outer peripheral surface of the second fixed barrel 20, and then extends in the circumferential direction of the second fixed barrel 20 (in FIG. 1, a part of the lead wire 60 is indicated by a two dot chain line), and is connected to a second lug plate 62 (see FIG. 3). In the present embodiment, the second lug plate 62 is fixed to a third fixed barrel 80 by a fixing member such as a screw, for example. The third fixed barrel 80 is disposed radially further outward than the second fixed barrel 20, and a part thereof is disposed radially further inward than the exterior barrel 30. The third fixed barrel 80 is made of resin and has no conductivity. The second lug plate 62 may be fixed to another member.

The second lug plate 62 is in contact with a plate spring 61 made of metal, and the plate spring 61 is in contact with the conductive exterior barrel 30. By using the second lug plate 62 and the plate spring 61, the lens barrel 100 can be assembled more easily than in the case where the lead wire 60 is directly connected to the exterior barrel 30 by soldering or the like, for example. In addition, by using the plate spring 61, even if there is a variation in the distance between the second lug plate 62 and the exterior barrel 30, the lead wire connected to the second lug plate 62 and the exterior barrel 30 can be electrically connected to each other reliably.

In this manner, the first fixed barrel 10 and the exterior barrel 30 are electrically connected by the conduction fixing mechanism 50, the second lug plate 62, and the plate spring 61. Since the exterior barrel 30 is electrically connected to the lens mount LM, the first fixed barrel 10 is electrically connected to the ground potential of the electric circuit provided in the camera body 200 via the exterior barrel 30 and the lens mount LM.

This can inhibit the occurrence of charging or discharging due to static electricity in the first fixed barrel 10 that has conductivity.

As described above in detail, according to the present embodiment, the lens barrel 100 includes the first fixed barrel 10 that has conductivity, the exterior barrel 30 and the lens mount LM that have conductivity and are disposed closer to the image plane side than the first fixed barrel 10, the second fixed barrel 20 that does not have conductivity and is at least partially disposed between the first fixed barrel 10 and the exterior barrel 30, and the conduction fixing mechanism 50 that fixes the diaphragm unit 40 to the second fixed barrel 20 and electrically connects the first fixed barrel 10 and the exterior barrel 30. Since the conduction fixing mechanism 50 has a function of fixing the diaphragm unit 40 and a conduction function of electrically connecting the first fixed barrel 10 to the exterior barrel 30, the number of components can be reduced, and the component cost of the lens barrel 100 can be reduced. Further, for example, compared to a case where the first fixed barrel 10 is connected to the exterior barrel 30 by a copper foil or the like, it is not necessary to add a conductive component, and it is not necessary to secure an installation space for the conductive component, and thus it is possible to inhibit an increase in the size of the lens barrel 100. In addition, since no copper foil is used, there is no peeling of the copper foil, which improves reliability.

In the present embodiment, the conduction fixing mechanism 50 includes the conductive compression coil spring 51 that is in contact with the lens holding frame F5 fixed to the first fixed barrel 10, and the screw portion 52 that penetrates through at least a part of the second fixed barrel 20, and the compression coil spring 51 and the screw portion 52 are electrically connected to each other. Accordingly, even if there are variations in the distance between the lens holding frame F5 and the screw portion 52 due to manufacturing errors or the like, the lens holding frame F5 (the first fixed barrel 10) and the screw portion 52 can be electrically connected to each other reliably by the compression coil spring 51.

In the present embodiment, the opening member 41 of the diaphragm unit 40 fixed to the second fixed barrel 20 does not have conductivity, and the screw portion 52 has the spring contact portion 52b that is in contact with the compression coil spring 51. This enables the lens holding frame F5 (first fixed barrel 10) and the screw portion 52 to be reliably electrically connected.

### Second Embodiment

In the above embodiment, the member fixed to the non-conductive second fixed barrel 20 by the conduction fixing mechanism 50 is the opening member 41 made of resin included in the diaphragm unit 40, but the member fixed to the second fixed barrel 20 by the conduction fixing mechanism 50 may have conductivity.

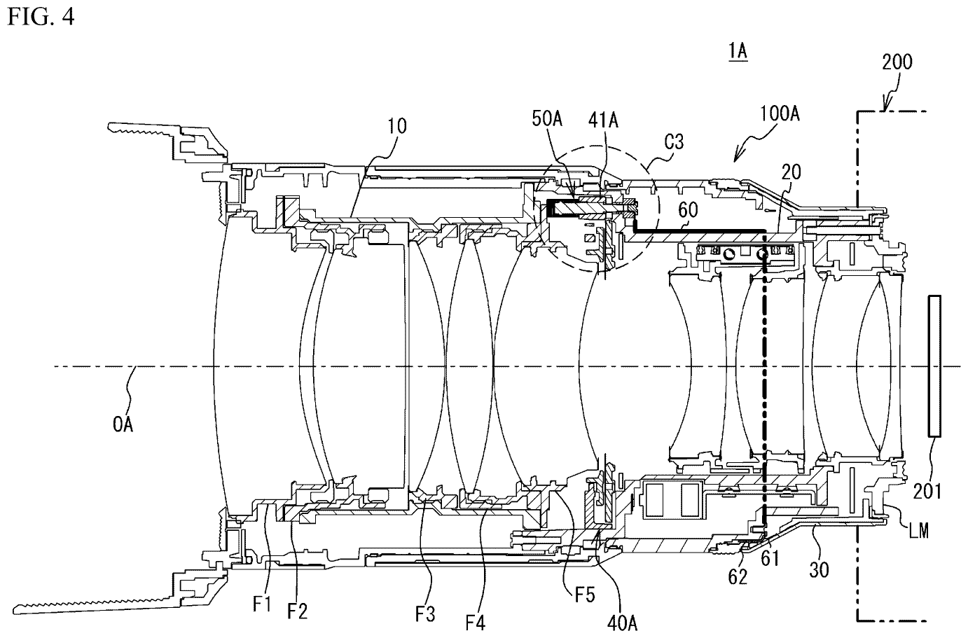

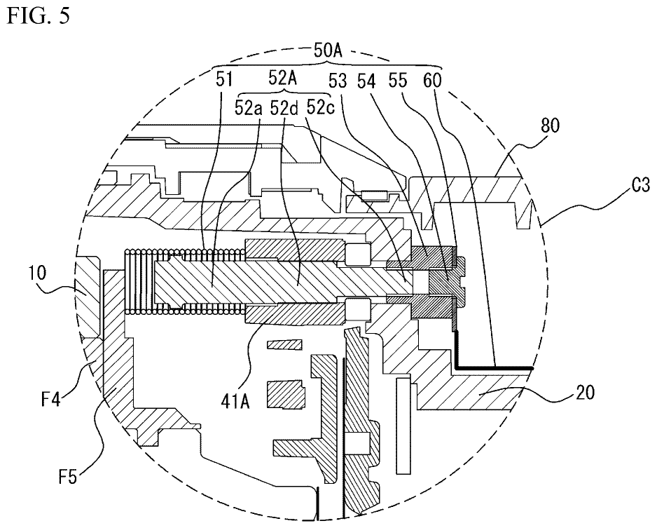

FIG. 4 is a diagram illustrating a camera 1A including a lens barrel 100A according to a second embodiment and the camera body 200. FIG. 5 is an enlarged view of a portion C3 enclosed by a broken line in FIG. 4.

As illustrated in FIG. 4, the lens barrel 100A according to the second embodiment includes the first fixed barrel 10, the second fixed barrel 20, the exterior barrel 30, the lens mount LM, and a diaphragm unit 40A.

The configurations of the first fixed barrel 10, the second fixed barrel 20, the exterior barrel 30, and the lens mount LM are the same as those in the first embodiment, and thus detailed description thereof will be omitted.

The diaphragm unit 40A according to the second embodiment includes an opening member 41A made of metal, and the opening member 41A is fixed to the second fixed barrel 20, whereby the diaphragm unit 40A is fixed to the second fixed barrel 20.

A conduction fixing mechanism 50A according to the second embodiment includes the compression coil spring 51, a screw portion 52A, the nut 53, the screw 54, the first lug plate 55, and the lead wire 60. The configurations of the compression coil spring 51, the nut 53, the screw 54, the first lug plate 55, and the lead wire 60 are the same as those of the first embodiment, and thus detailed description thereof will be omitted.

The screw portion 52A of the second embodiment is different from the screw portion 52 of the first embodiment in that the screw portion 52A does not have the spring contact portion 52b. Since the screw portion 52A does not have the spring contact portion 52b, one end of the compression coil spring 51 is in contact with the opening member 41A. Since the opening member 41A has conductivity and is in contact with the screw portion 52A, one end of the compression coil spring 51 is in contact with the opening member 41A and the other end is in contact with the lens holding frame F5, so that the first fixed barrel 10 and the screw portion 52A are electrically connected to each other.

Other configurations are the same as those of the first embodiment, and thus the detailed description thereof will be omitted. As described above, the fixed member that is fixed to the second fixed barrel 20 by the conduction fixing mechanism 50A may have conductivity.

In the above embodiment, the compression coil spring 51 is used to electrically connect the lens holding frame F5 and the screw portion 52, 52A regardless of variations in the distance between the lens holding frame F5 and the screw portion 52, 52A due to manufacturing errors or the like, but this does not intend to suggest any limitation. Instead of the compression coil spring 51, for example, an expandable tubular member such as a conductive bellows that expands and contracts in a direction parallel to the optical axis OA may be used. Further, instead of the compression coil spring 51, the lens holding frame F5 and the screw portion 52, 52A may be connected by copper wires or the like.

In the above embodiment, the first lug plate 55 and the second lug plate 62 are provided and connected to each other by the lead wire 60, but this does not intend to suggest any limitation. For example, when the length of the non-conductive second fixed barrel 20 in the optical axis OA direction is short and the distance between the screw portion 52, 52A, and the exterior barrel 30 is short, the plate spring 61 may be fixed to the nut 53 by the screw 54 to cause the plate spring 61 to be in contact with the exterior barrel 30.

In the above embodiment, the screw portion 52, 52A extend in the direction parallel to the optical axis OA, but the screw portion 52, 52A may extend in the radial direction of a circle centered on the optical axis OA depending on the structure of the lens barrel.

In the above embodiment, the compression coil spring 51 is in contact with the lens holding frame F5, but when the lens barrel 100, 100A does not have the lens holding frame F5, the first fixed barrel 10 and the compression coil spring 51 are in contact with each other.

In the above embodiment, the conduction fixing mechanism 50, 50A fixes the diaphragm unit 40, 40A to the second fixed barrel 20, but this does not intend to suggest any limitation. The member fixed to the second fixed barrel 20 by the conduction fixing mechanism 50, 50A may be, for example, a lens holding frame. In this case, if the lens holding frame is made of metal, the conduction fixing mechanism 50 is used, and if the lens holding frame is made of resin, the conduction fixing mechanism 50A is used. In the above embodiment, the conduction fixing mechanism 50, 50A is used at one of the three points at which the diaphragm unit 40, 40A is fixed, but the conduction fixing mechanism 50, 50A may also be used at the remaining two points.

The first fixed barrel 10 may be fixed to the second fixed barrel 20 by using the conduction fixing mechanism 50, 50A. In this case, the screw portion 52, 52A and the first fixed barrel 10 are in contact with each other, and thereby the first fixed barrel 10 and the screw portion 52, 52A are electrically connected to each other, and thus the compression coil spring 51 can be omitted.

The above-described embodiments are preferred examples. However, the present disclosure does not intend to suggest any limitation, and various modifications can be made without departing from the scope of the present disclosure, and any combination of constituent elements may be used.

1. A lens barrel comprising:
a first member having conductivity;
a second member that has conductivity and is disposed closer to an image plane side than the first member;
a non-conductive member at least a portion of which is disposed between the first member and the second member; and
a conductive member that fixes a fixed member to the non-conductive member and electrically connects the first member and the second member.

2. The lens barrel according to claim 1, wherein a portion of the conductive member penetrates through a part of the non-conductive member.

3. The lens barrel according to claim 1, wherein a part of the conductive member extends in a direction parallel to an optical axis.

4. The lens barrel according to claim 1, wherein the second member includes a first barrel having conductivity, and a mount.

5. The lens barrel according to claim 1,
wherein the conductive member includes a lead wire, and
wherein the lead wire is disposed along an outer surface of the non-conductive member.

6. The lens barrel according to claim 1,
wherein the conductive member includes:
an elastic member that has conductivity and is in contact with the first member; and
a fixing portion that penetrates through at least a part of the non-conductive member,
wherein the elastic member and the fixing portion are electrically connected to each other.

7. The lens barrel according to claim 6,
wherein the fixed member has no conductivity, and
wherein the fixing portion of the conductive member includes a contact portion that is in contact with the elastic member.

8. The lens barrel according to claim 7,
wherein the first member and the fixing portion are not in contact with each other in an optical axis direction, and
wherein the elastic member is in contact with the first member and the fixing portion.

9. The lens barrel according to claim 1, wherein the fixed member is a diaphragm unit.

10. The lens barrel according to claim 1, wherein the fixed member is the first member.

11. The lens barrel according to claim 6,
wherein the fixed member has conductivity, and
wherein the elastic member of the conductive member is in contact with the first member and the fixed member.

12. An imaging device comprising the lens barrel according to claim 1.
